(19) United States
(12) Patent Application Publication
(10) Pub. No.: US 2015/0149540 A1
(43) Pub. Date: May 28, 2015

(54) Manipulating Audio and/or Speech in a Virtual Collaboration Session

(71) Applicant: Dell Products, L.P., Round Rock, TX (US)

(72) Inventors: Clifton J. Barker, Austin, TX (US); Michael S. Gatson, Austin, TX (US); Todd Swierk, Austin, TX (US); Jason A. Shepherd, Austin, TX (US); Yuan-Chang Lo, Austin, TX (US)

(73) Assignee: Dell Products, L.P., Round Rock, TX (US)

(21) Appl. No.: 14/088,139

(22) Filed: Nov. 22, 2013

(51) Int. Cl. H04L 29/06

(52) U.S. Cl. CPC H04L 65/403
USPC 709/204

(57) ABSTRACT

Systems and methods for manipulating audio and/or speech in a virtual collaboration session. In some embodiments, a method may include capturing speech originated by a given one of a plurality of participants during a virtual collaboration session, and capturing a discrete collaboration event originated by the given participant during the virtual collaboration session. The method may also include synchronizing the speech with the event and storing the synchronized speech and event.

### FIELD

This disclosure relates generally to computer systems, and more specifically, to systems and methods for manipulating audio and/or speech in a virtual collaboration session.

### BACKGROUND

As the value and use of information continues to increase, individuals and businesses seek additional ways to process and store information. One option is an Information Handling System (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, global communications, etc. In addition, IHSs may include a variety of hardware and software components that may be configured to process, store, and communicate information and may include one or more computer systems, data storage systems, and networking systems.

In some situations, two or more IHSs may be operated by different users or team members participating in a “virtual collaboration session” or “virtual meeting.” Generally speaking, “virtual collaboration” is a manner of collaboration between users that is carried out via technology-mediated communication. Although virtual collaboration may follow similar processes as conventional collaboration, the parties involved in a virtual collaboration session communicate with each other, at least in part, through technological channels.

In the case of an IHS- or computer-mediated collaboration, a virtual collaboration session may include, for example, audio conferencing, video conferencing, a chat room, a discussion board, text messaging, instant messaging, shared database(s), whiteboarding, wikis, application specific groupware, or the like. For instance, “whiteboarding” is the placement of shared images, documents, or other files on a shared on-screen notebook or whiteboard. Videoconferencing and data conferencing functionality may let users annotate these shared documents, as if on a physical whiteboard. With such an application, several people may be able to work together remotely on the same materials during a virtual collaboration session.

### SUMMARY

Embodiments of systems and methods for manipulating audio and/or speech in a virtual collaboration session are described herein. In an illustrative, non-limiting embodiment, a method may include capturing speech originated by a given one of a plurality of participants during a virtual collaboration session, capturing a discrete collaboration event originated by the given participant during the virtual collaboration session, synchronizing the speech with the event, and storing the synchronized speech and event.

For example, the virtual collaboration session may include a whiteboarding session. The discrete collaboration event may include a drawing on a whiteboard, and capturing the discrete collaboration event may include capturing a vector of plotted points on the whiteboard. The method may also include capturing a vector of plotted points upon expiration of a configurable timer or in response to the participant having stopped drawing on the whiteboard for a preselected period of time.

In some cases, the discrete collaboration event may include a sharing of content between the given participant and at least another one of the plurality of participants, and wherein storing the synchronized speech and event includes storing a copy of the content. Additionally or alternatively, the discrete collaboration event may include an initiation of a private collaboration session between the given participant and at least another one of the plurality of participants to the exclusion of at least yet another of the plurality of participants, and storing the synchronized speech and event may include storing an indication of the private collaboration session. The synchronized speech and event may be stored in distinct layers of the same file.

The method also further include converting the speech to text, synchronizing the text with the speech and the event, and storing the synchronized text, speech, and event. The method may further include transmitting the synchronized speech and event to a remotely located server.

In another illustrative, non-limiting embodiment, another method may include receiving data from a given one of a plurality of participants of a whiteboarding session, where the data includes speech synchronized with an indication of a discrete collaboration event, where the speech and the discrete collaboration event are originated by the given participant during the whiteboarding session, where the discrete collaboration event includes a drawing on a whiteboard, and wherein the data includes a vector of plotted points on the whiteboard; and storing the data.

In some cases, the discrete collaboration event may include a sharing of content between the given participant and at least another one of the plurality of participants, and the data may include a representation of the content. In other cases, the discrete collaboration event may include an initiation of a private collaboration session between the given participant and at least another one of the plurality of participants to the exclusion of at least yet another of the plurality of participants, and the data may include a representation of the private collaboration session.

The method may also include receiving a request to playback at least a portion of the whiteboarding session, and providing a portion of the data corresponding to the request to the requesting device. The method may further include allowing the requesting device to playback the whiteboarding session in a non-linear manner.

In some implementations, the data may include text corresponding to the speech and the text may be synchronized with the speech and the event, and the method may include allowing the requesting device to search for a keyword in the text, and providing a portion of the data corresponding to the keyword to the requesting device.

The method may also include receiving additional data at the IHS from at least another one of the plurality of participants, where the data includes other speech synchronized with an indication of another discrete collaboration event, where the other speech and the other discrete collaboration event are originated by at least another participant during the whiteboarding session, synchronizing the data with the additional data, and storing the additional data. Additionally or alternatively, the method may include receiving a request to playback at least a portion of the whiteboarding session associated with a selected one or more of the plurality of participants to the exclusion of at least another one or more of the plurality of participants, and providing a portion of the data corresponding to the request to the requesting device.

In yet another illustrative, non-limiting embodiment, a method may include receiving data from a given one of a plurality of participants of a virtual collaboration session, where the data includes an audio portion synchronized with a text portion corresponding to the audio and where the audio is generated by the given participant during the virtual collaboration session, and providing the text portion to another one of the plurality of participants during the virtual collaboration session, wherein the text portion is configured to be displayed on a horizontally scrolling marquee via a graphical interface displayed to the other participant.

In some cases, the horizontally scrolling marquee may be configured to allow the other participant to backward or forward scroll the text using a gesture during the virtual collaboration session. Additionally or alternatively, the horizontally scrolling marquee may be configured to allow the other participant to send content to the given participant during the virtual collaboration session by dragging and dropping the content onto the marquee.

In some embodiments, one or more of the techniques described herein may be performed, at least in part, by an Information Handling System (IHS) operated by a given one of a plurality of participants of a virtual collaboration session. In other embodiments, these techniques may be performed by an IHS having a processor and a memory coupled to the processor, the memory including program instructions stored thereon that, upon execution by the processor, cause the IHS to execute one or more operations. In yet other embodiments, a non-transitory computer-readable medium may have program instructions stored thereon that, upon execution by an IHS, cause the IHS to execute one or more of the techniques described herein.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a diagram illustrating an example of an environment where systems and methods for manipulating audio and/or speech in a virtual collaboration session may be implemented according to some embodiments.

FIG. 2 is a block diagram of a cloud-hosted or enterprise service infrastructure for managing information and content sharing in a virtual collaboration session according to some embodiments.

FIG. 3 is a block diagram of an example of an Information Handling System (IHS) according to some embodiments.

FIG. 4 is a flowchart of a method for drawing and audio correlation according to some embodiments.

FIG. 5 is a screenshot of a client application on a tablet device according to some embodiments.

FIG. 6 is a flowchart of a method for transmitting speech-to-text marquee data according to some embodiments.

FIG. 7 is a flowchart of a method for receiving speech-to-text marquee data according to some embodiments.

FIG. 8 is a flowchart of a method for serving speech-to-text marquee data according to some embodiments.

FIG. 9 is a screenshot illustrating a horizontally scrolling marquee according to some embodiments.

### DETAILED DESCRIPTION

To facilitate explanation of the various systems and methods discussed herein, the following description has been split into sections. It should be noted, however, that the various sections, headings, and subheadings used herein are for organizational purposes only, and are not meant to limit or otherwise modify the scope of the description or the claims.

Overview

The inventors hereof have recognized a need for new tools that enable better team interactions and improve effectiveness in the workplace, particularly as the workforce becomes more geographically-distributed and as the volume of business information created and exchanged increases to unprecedented levels. Existing tools intended to facilitate collaboration include digital whiteboarding, instant messaging, file sharing, and unified communication platforms. Unfortunately, such conventional tools are fragmented and do not adequately address certain problems specific to real-time interactions. In addition, these tools do not capitalize on contextual information for further gains in productivity and ease of use.

Examples of problems faced by distributed teams include the lack of a universally acceptable manner of performing whiteboarding sessions. The use of traditional dry erase boards in meeting rooms excludes or limits the ability of remote workers to contribute and current digital whiteboarding options are unnatural to use and are therefore not being adopted. In addition, there are numerous inefficiencies in setting up meeting resources, sharing in real-time, and distribution of materials after meetings such as emailing notes, presentation materials, and digital pictures of whiteboard sketches. Fragmentation across tool sets and limited format optimization for laptops, tablets, and the use of in-room projectors present a further set of issues. Moreover, the lack of continuity between meetings and desk work and across a meeting series including common file repositories, persistent notes and whiteboard sketches, and historical context can create a number of other problems and inefficiencies.

To address these, and other concerns, the inventors hereof have developed systems and methods that address, among other things, the setting up of resources for a virtual collaboration session, the taking of minutes and capture of whiteboard sketches, the creation and management to agendas, and/or provide the ability to have the right participants and information on hand for a collaboration session.

In some embodiments, these systems and methods focus on leveraging technology to increase effectiveness of real-time team interactions in the form of a “connected productivity framework.” A digital or virtual workspace part of such a framework may include an application that enables both in-room and remote users the ability to interact easily with the collaboration tool in real-time. The format of such a virtual workspace may be optimized for personal computers (PCs), tablets, mobile devices, and/or in-room projection. The workspace may be shared across all users' personal devices, and it may provide a centralized location for presenting files and whiteboarding in real-time and from anywhere. The integration of context with unified communication and note-taking functionality provides improved audio, speaker identification, and automation of meeting minutes.

The term “context,” as used herein, refers to information that may be used to characterize the situation of an entity. An entity is a person, place, or object that is considered relevant to the interaction between a user and an application, including the user and application themselves. Examples of context include, but are not limited to, location, people and devices nearby, and calendar events.

For instance, a connected productivity framework may provide, among other things, automation of meeting setup, proximity awareness for automatic joining of sessions, Natural User Interface (NUI) control of a workspace to increase the usability and adoption, intelligent information management and advanced indexing and search, and/or meeting continuity. Moreover, a set of client capabilities working in concert across potentially disparate devices may include: access to a common shared workspace with public and private workspaces for file sharing and real-time collaboration, advanced digital whiteboarding with natural input to dynamically control access, robust search functionality to review past work, and/or the ability to seamlessly moderate content flow, authorization, and intelligent information retrieval.

When certain aspects of the connected productivity framework described herein are applied to a projector, for instance, the projector may become a fixed point of reference providing contextual awareness. The projector may maintain a relationship to the room and associated resources (e.g., peripheral hardware). This allows the projector be a central hub for organizing meetings, and it does not necessarily rely on a host user and their device to be present for meeting and collaborating.

In some implementations, a cloud-hosted or enterprise service infrastructure as described herein may allow virtual collaboration session to be persistent. Specifically, once a document, drawing, or other content is used during a whiteboard session, for example, the content may be tagged as belonging to that session. When a subsequent session takes places that is associated with a previous session (and/or when the previous session is resumed at a later time), the content and transactions previously performed in the virtual collaboration environment may be retrieved so that, to participants, there is meeting continuity. In some embodiments, the systems and methods described herein may provide “digital video recorder” (DVR)—type functionality for collaboration sessions, such that participants may be able to record meeting events and play those events back at a later time, or “pause” the in-session content in temporary memory. The latter feature may enable a team to pause a meeting when they exceed the scheduled time and resume the in-session content in another available conference room, for example.

As will be understood by a person of ordinary skill in the art in light of this disclosure, virtually any commercial business setting that requires meeting or collaboration may implement one or more aspects of the systems and methods described herein. Additionally, aspects of the connected productivity framework described herein may be expanded to other areas, such as educational verticals for use in classrooms, or to consumers for general meet-ups.

Virtual Collaboration Architecture

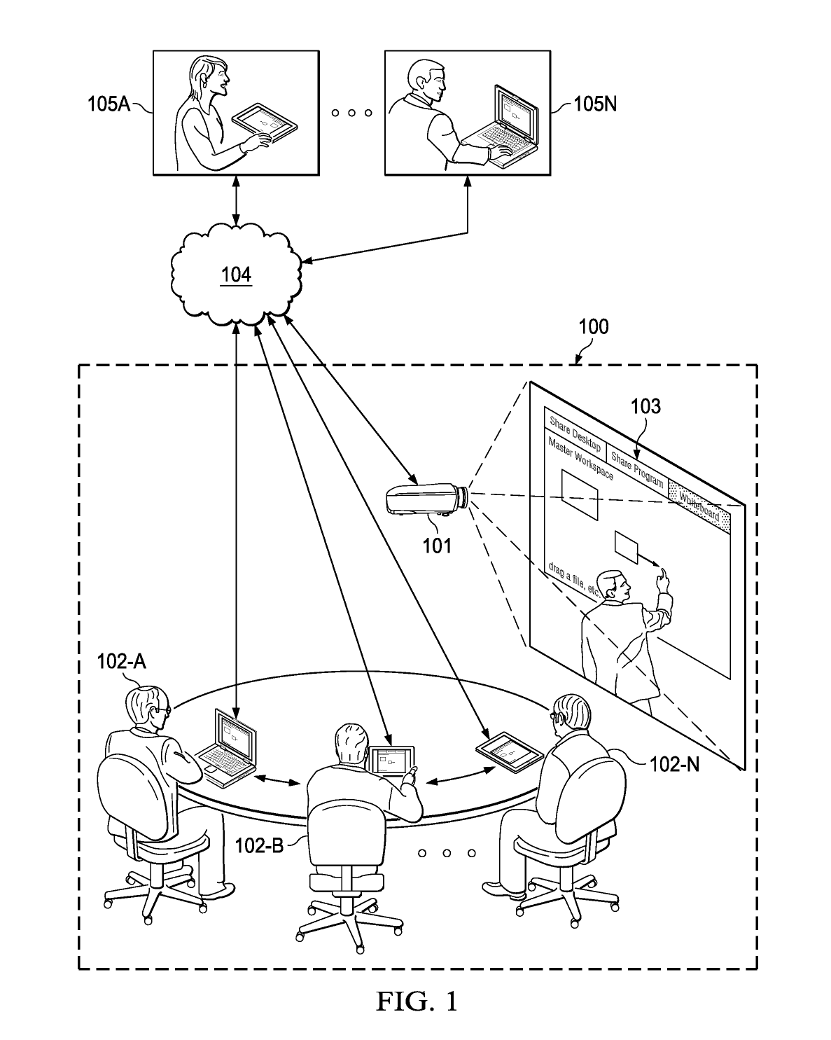

Turning now to FIG. 1, a diagram illustrating an example of an environment where systems and methods for managing information and content sharing in a virtual collaboration session may be implemented is depicted according to some embodiments. As shown, interactive collaboration tool 101 operates as a central meeting host and/or shared digital whiteboard for conference room 100 in order to enable a virtual collaboration session. In some embodiments, interactive collaboration tool may include (or otherwise be coupled to) a real-time communications server, a web server, an object store server, and/or a database. Moreover, interactive collaboration tool 101 may be configured with built-in intelligence and contextual awareness to simplify meeting setup and provide continuity between meetings and desk work.

In some implementations, for example, interactive collaboration tool 101 may include a video projector or any other suitable digital and/or image projector that receives a video signal (e.g., from a computer, a network device, or the like) and projects corresponding image(s) 103 on a projection screen using a lens system or the like. In this example, image 103 corresponds to a whiteboarding application, but it should be noted that any collaboration application may be hosted and/or rendered using tool 101 during a virtual collaboration session.

Any number of in-room participants 102A-N and any number of remote participants 105A-N may each operate a respective IHS or computing device including, for example, desktops, laptops, tablets, or smartphones. In a typical situation, in-room participants 102A-N are in close physical proximity to interactive collaboration tool 101, whereas remote participants 105A-N are located in geographically distributed or remote locations, such as other offices or their homes. In other situations, however, a given collaboration session may include only in-room participants 102A-N or only remote participants 105A-N.

With regard to participants 102A-N and 105A-N, it should be noted that users participating in a virtual collaboration session or the like may have different classifications. For example, a participant may include a member of the session. A moderator may be an owner of the meeting workspace and leader that moderates the participants of the meeting. Often the moderator has full control of the session, including material content, what is displayed on the master workspace, and the invited list of participants. Moreover, an editor may include a meeting participant or the moderator who has write privileges to update content in the meeting workspace.

Interactive collaboration tool 101 and participants 102A-N and 105A-N may include any end-point device capable of audio or video capture, and that has access to network 104. In various embodiments, telecommunications network 104 may include one or more wireless networks, circuit-switched networks, packet-switched networks, or any combination thereof to enable communications between two or more of IHSs. For example, network 104 may include a Public Switched Telephone Network (PSTN), one or more cellular networks (e.g., third generation (3G), fourth generation (4G), or Long Term Evolution (LTE) wireless networks), satellite networks, computer or data networks (e.g., wireless networks, Wide Area Networks (WANs), metropolitan area networks (MANs), Local Area Networks (LANs), Virtual Private Networks (VPN), the Internet, etc.), or the like.

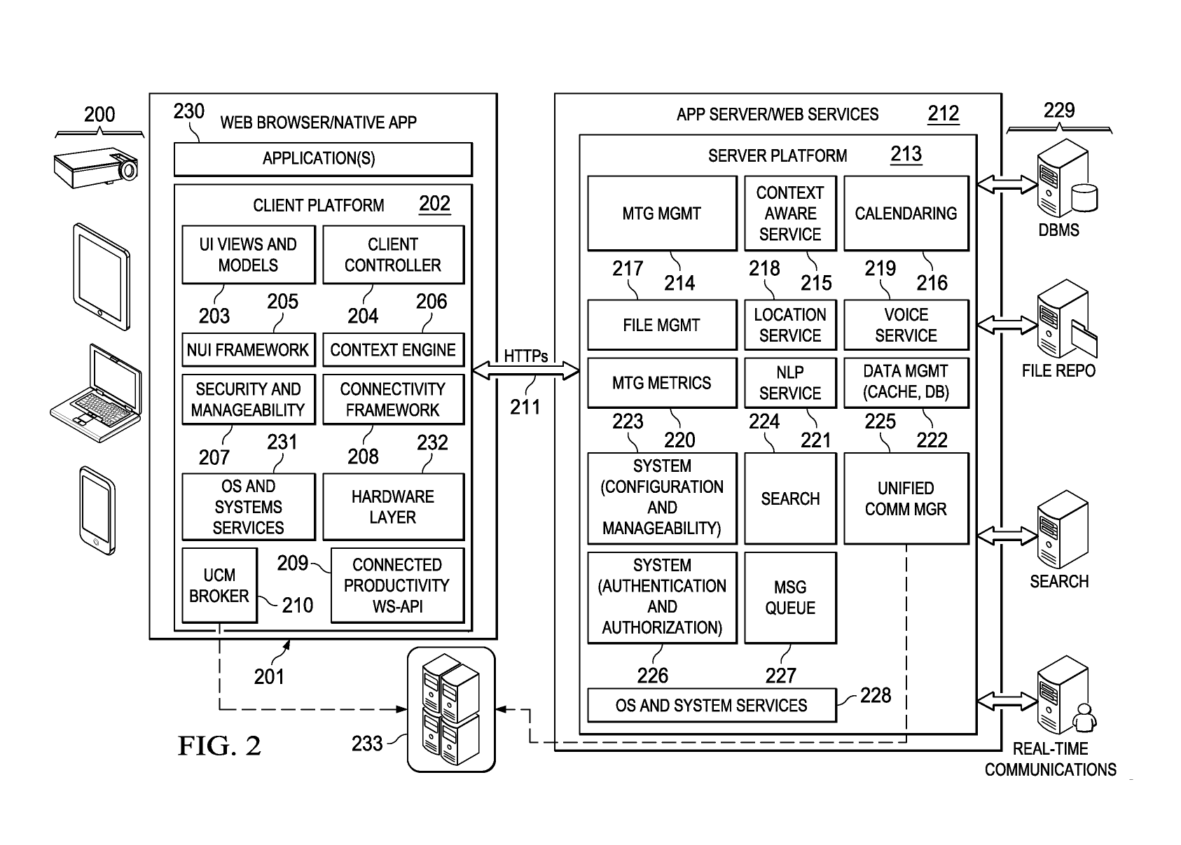

FIG. 2 is a block diagram of a cloud-hosted or enterprise service infrastructure. In some embodiments, the infrastructure of FIG. 2 may be implemented in the context of environment of FIG. 1 for managing information and content sharing in a virtual collaboration session. Particularly, one or more participant devices 200 (operated by in-room participants 102A-N and/or remote participants 105A-N) may be each configured to execute client platform 202 in the form of a web browser or native application 201. As such, on the client side, one or more virtual collaboration application(s) 230 (e.g., a whiteboarding application or the like) may utilize one or more of modules 203-210, 231, and/or 232 to perform one or more virtual collaboration operations. Application server or web services 212 may contain server platform 213, and may be executed, for example, by interactive collaboration tool 101.

As illustrated, web browser or native application 201 may be configured to communicate with application server or web services 212 (and vice versa) via link 211 using any suitable protocol such as, for example, Hypertext Transfer Protocol (HTTP) or HTTP Secure (HTTPS). Each module within client platform 202 and application server or web services 212 may be responsible to perform a specific operation or set of operations within the collaborative framework.

Particularly, client platform 202 may include user interface (UI) view & models module 203 configured to provide a lightweight, flexible user interface that is portable across platforms and device types (e.g., web browsers in personal computers, tablets, and phones using HyperText Markup Language (HTML) 5, Cascading Style Sheets (CSS) 3, and/or JavaScript). Client controller module 204 may be configured to route incoming and outgoing messages accordingly based on network requests or responses. Natural User Interface (NUI) framework module 205 may be configured to operate various hardware sensors for touch, multi-point touch, visual and audio provide the ability for voice commands and gesturing (e.g., touch and 3D based). Context engine module 206 may be configured to accept numerous inputs such as hardware sensor feeds and text derived from speech. In some instances, context engine module 206 may be configured to perform operations such as, for example, automatic participant identification, automated meeting joining and collaboration via most effective manner, location aware operations (e.g., geofencing, proximity detection, or the like) and associated management file detection/delivery, etc.

Client platform 202 also includes security and manageability module 207 configured to perform authentication and authorization operations, and connectivity framework module 208 configured to detect and connect with other devices (e.g., peer-to-peer). Connected productivity module 209 may be configured to provide a web service API (WS-API) that allows clients and host to communicate and/or invoke various actions or data querying commands. Unified Communication (UCM) module 210 may be configured to broker audio and video communication including file transfers across devices and/or through third-party systems 233.

Within client platform 202, hardware layer 232 may include a plurality of gesture tracking (e.g., touchscreen or camera), audio and video capture (e.g., camera, microphone, etc.), and wireless communication devices or controllers (e.g., Bluetooth®, WiFi, Near Field Communications, or the like). Operating system and system services layer 231 may have access to hardware layer 232, upon which modules 203-210 rest. In some cases, third-party plug-ins (not shown) may be communicatively coupled to virtual collaboration application 230 and/or modules 203-210 via an Application Programming Interface (API).

Server platform 213 includes meeting management module 214 configured to handle operations such as, for example, creating and managing meetings, linking virtual workspace, notifying participants of invitations, and/or providing configuration for auto calling (push/pull) participants upon start of a meeting, among others. Context aware service 215 may be configured to provide services used by context engine 206 of client platform 202. Calendaring module 216 may be configured to unify participant and resource scheduling and to provide smart scheduling for automated search for available meeting times.

Moreover, server platform 213 also includes file management module 217 configured to provide file storage, transfer, search and versioning. Location service module 218 may be configured to perform location tracking, both coarse and fine grained, that relies on WiFi geo-location, Global Positioning System (GPS), and/or other location technologies. Voice service module 219 may be configured to perform automated speech recognition, speech-to-text, text-to-speech conversation and audio archival. Meeting metrics module 220 may be configured to track various meeting metrics such as talk time, topic duration and to provide analytics for management and/or participants.

Still referring to server platform 213, Natural Language Processing (NLP) service module 221 may be configured to perform automatic meeting summation (minutes), conference resolution, natural language understanding, named entity recognition, parsing, and disambiguation of language. Data management module 222 may be configured to provide distributed cache and data storage of application state and session in one or more databases. System configuration & manageability module 223 may provide the ability to configure one or more other modules within server platform 213. Search module 224 may be configured to enable data search operations, and UCM manager module 225 may be configured to enable operations performed by UCM broker 210 in conjunction with third-party systems 233.

Security (authentication & authorization) module 226 may be configured to perform one or more security or authentication operations, and message queue module 227 may be configured to temporarily store one or more incoming and/or outgoing messages. Within server platform 213, operating system and system services layer 228 may allow one or more modules 214-227 to be executed.

In some embodiments, server platform 213 may be configured to interact with a number of other servers 229 including, but not limited to, database management systems (DBMSs), file repositories, search engines, and real-time communication systems. Moreover, UCM broker 210 and UCM manager 225 may be configured to integrate and enhance third-party systems and services (e.g., Outlook®, Gmail®, Dropbox®, Box.net®, Google Cloud®, Amazon Web Services®, Salesforce®, Lync®, WebEx®, Live Meeting®) using a suitable protocol such as HTTP or Session Initiation Protocol (SIP).

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory.

Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components.

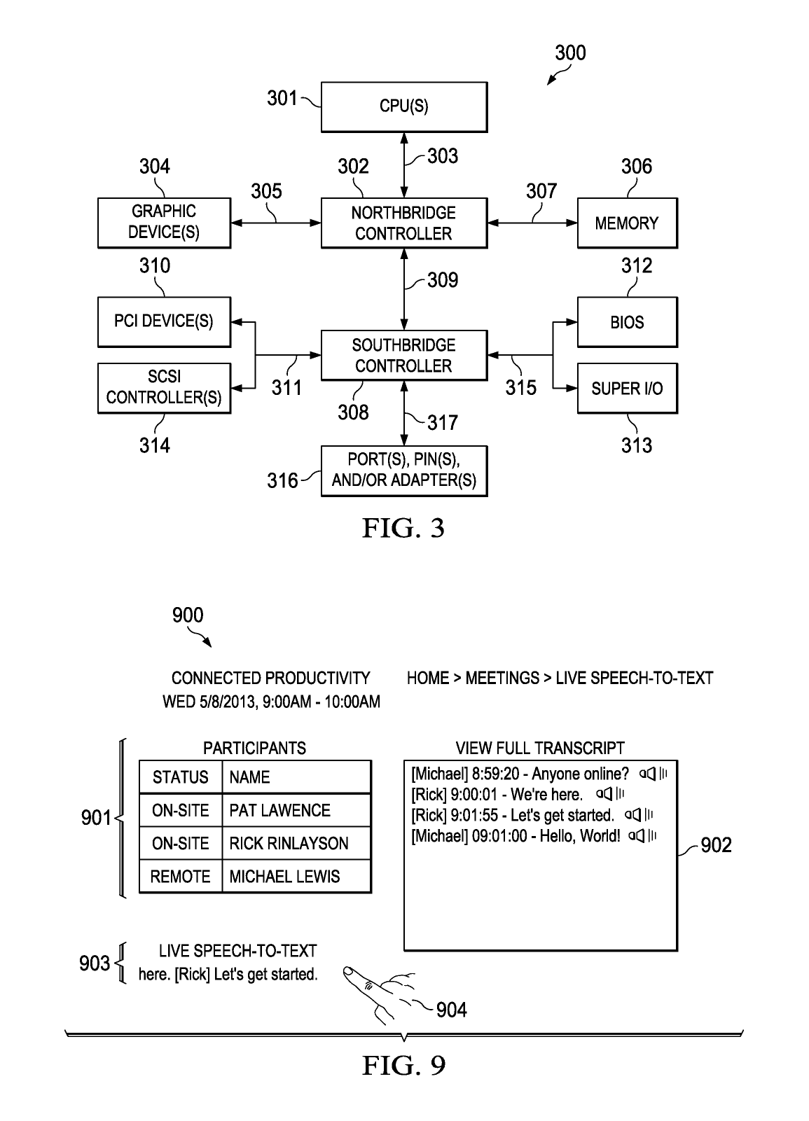

FIG. 3 is a block diagram of an example of an IHS. In some embodiments, IHS 300 may be used to implement any of computer systems or devices 101, 102A-N, and/or 105A-N. As shown, IHS 300 includes one or more CPUs 301. In various embodiments, IHS 300 may be a single-processor system including one CPU 301, or a multi-processor system including two or more CPUs 301 (e.g., two, four, eight, or any other suitable number). CPU(s) 301 may include any processor capable of executing program instructions. For example, in various embodiments, CPU(s) 301 may be general-purpose or embedded processors implementing any of a variety of Instruction Set Architectures (ISAs), such as the x86, POWERPC®, ARM®, SPARC®, or MIPS® ISAs, or any other suitable ISA. In multi-processor systems, each of CPU(s) 301 may commonly, but not necessarily, implement the same ISA.

CPU(s) 301 are coupled to northbridge controller or chipset 301 via front-side bus 303. Northbridge controller 302 may be configured to coordinate I/O traffic between CPU(s) 301 and other components. For example, in this particular implementation, northbridge controller 302 is coupled to graphics device(s) 304 (e.g., one or more video cards or adaptors) via graphics bus 305 (e.g., an Accelerated Graphics Port or AGP bus, a Peripheral Component Interconnect or PCI bus, or the like). Northbridge controller 302 is also coupled to system memory 306 via memory bus 307. Memory 306 may be configured to store program instructions and/or data accessible by CPU(s) 301. In various embodiments, memory 306 may be implemented using any suitable memory technology, such as static RAM (SRAM), synchronous dynamic RAM (SDRAM), nonvolatile/Flash-type memory, or any other type of memory.

Northbridge controller 302 is coupled to southbridge controller or chipset 308 via internal bus 309. Generally speaking, southbridge controller 308 may be configured to handle various of IHS 300's I/O operations, and it may provide interfaces such as, for instance, Universal Serial Bus (USB), audio, serial, parallel, Ethernet, or the like via port(s), pin(s), and/or adapter(s) 316 over bus 317. For example, southbridge controller 308 may be configured to allow data to be exchanged between IHS 300 and other devices, such as other IHSs attached to a network (e.g., network 104). In various embodiments, southbridge controller 308 may support communication via wired or wireless general data networks, such as any suitable type of Ethernet network, for example; via telecommunications/telephony networks such as analog voice networks or digital fiber communications networks; via storage area networks such as Fiber Channel SANs; or via any other suitable type of network and/or protocol.

Southbridge controller 308 may also enable connection to one or more keyboards, keypads, touch screens, scanning devices, voice or optical recognition devices, or any other devices suitable for entering or retrieving data. Multiple I/O devices may be present in IHS 300. In some embodiments, I/O devices may be separate from IHS 300 and may interact with IHS 300 through a wired or wireless connection. As shown, southbridge controller 308 is further coupled to one or more PCI devices 310 (e.g., modems, network cards, sound cards, or video cards) and to one or more SCSI controllers 314 via parallel bus 311. Southbridge controller 308 is also coupled to Basic I/O System (BIOS) 312 and to Super I/O Controller 313 via Low Pin Count (LPC) bus 315.

BIOS 312 includes non-volatile memory having program instructions stored thereon. Those instructions may be usable CPU(s) 301 to initialize and test other hardware components and/or to load an Operating System (OS) onto IHS 300. Super I/O Controller 313 combines interfaces for a variety of lower bandwidth or low data rate devices. Those devices may include, for example, floppy disks, parallel ports, keyboard and mouse, temperature sensor and fan speed monitoring/control, among others.

In some cases, IHS 300 may be configured to provide access to different types of computer-accessible media separate from memory 306. Generally speaking, a computer-accessible medium may include any tangible, non-transitory storage media or memory media such as electronic, magnetic, or optical media—e.g., magnetic disk, a hard drive, a CD/DVD-ROM, a Flash memory, etc. coupled to IHS 300 via northbridge controller 302 and/or southbridge controller 308.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

A person of ordinary skill in the art will appreciate that IHS 300 is merely illustrative and is not intended to limit the scope of the disclosure described herein. In particular, any computer system and/or device may include any combination of hardware or software capable of performing certain operations described herein. In addition, the operations performed by the illustrated components may, in some embodiments, be performed by fewer components or distributed across additional components. Similarly, in other embodiments, the operations of some of the illustrated components may not be performed and/or other additional operations may be available.

For example, in some implementations, northbridge controller 302 may be combined with southbridge controller 308, and/or be at least partially incorporated into CPU(s) 301. In other implementations, one or more of the devices or components shown in FIG. 3 may be absent, or one or more other components may be added. Accordingly, systems and methods described herein may be implemented or executed with other IHS configurations.

Virtual Collaboration Application

In various embodiments, the virtual collaboration architecture described above may be used to implement a number of systems and methods in the form of virtual collaboration application 230 shown in FIG. 2. These systems and methods may be related to meeting management, shared workspace (e.g., folder sharing control, remote desktop, or application sharing), digital whiteboard (e.g., collaboration arbitration, boundary, or light curtain based input recognition), and/or personal engagement (e.g., attention loss detection, eye tracking, etc.), some of which are summarized below and explained in more detail in subsequent section(s).

For example, virtual collaboration application 230 may implement systems and/or methods for managing public and private information in a collaboration session. Both public and private portions of a virtual collaboration workspace may be incorporated into the same window of a graphical user interface. Meeting/project content in the public and private portions may include documents, email, discussion threads, meeting minutes, whiteboard drawings, lists of participants and their status, and calendar events. Tasks that may be performed using the workspace include, but are not limited to, editing of documents, presentation of slides, whiteboard drawing, and instant messaging with remote participants.

Additionally or alternatively, virtual collaboration application 230 may implement systems and/or methods for real-time moderation of content sharing to enable the dynamic moderating of participation in a shared workspace during a meeting. Combining a contact list alongside the shared workspace and folder system in one simplified and integrated User Interface (UI) puts all input and outputs in one window so users simply drag and drop content, in-session workspace tabs, and people to and from each other to control access rights and share. Behavior rules dictating actions may be based on source and destination for drag and drop of content and user names. Actions may differ depending on whether destination is the real-time workspace or file repository. Also, these systems and methods provide aggregation of real-time workspace (whiteboard/presentation area) with file repository and meeting participant lists in one UI.

Additionally or alternatively, virtual collaboration application 230 may implement systems and/or methods for correlating stroke drawings to audio. Such systems and methods may be configured to correlate participants' audio and drawing input by synchronization of event triggers on a given device(s). As input is received (drawing, speech, or both), the data are correlated via time synchronization, packaged together, and persisted on a backend system, which provides remote synchronous and asynchronous viewing and playback features for connected clients. The data streams result in a series of layered inputs that link together the correlated audio and visual (sketches). This allows participants to revisit previous collaboration settings. Not only can a user playback the session in its entirety, each drawing layer and corresponding audio can be reviewed non-linearly.

Additionally or alternatively, virtual collaboration application 230 may implement systems and/or methods for live speech-to-text broadcast communication. Such systems and methods may be configured to employ Automatic Speech Recognition (ASR) technology combined with a client-server model and in order to synchronize the converted speech's text transcript for real-time viewing and later audio playback within a scrolling marquee (e.g., “news ticker”). In conjunction with the converted speech's text the audio data of the speech itself is persisted on a backend system, it may provide remote synchronous and asynchronous viewing and playback features for connected clients.

Additionally or alternatively, virtual collaboration application 230 may implement systems and/or methods for dynamic whiteboarding drawing area. In some cases, a virtual border may be developed around the center of a user's cursor as soon as that user starts to draw in a shared whiteboard space. The border may simulate the physical space that the user would block in front of a traditional wall-mounted whiteboard and is represented to all session participants as a color-coded shaded area or outline, for example. It provides dynamic virtual border for reserving drawing space with automatic inactivity time out and resolution with other borders, as well as moderation control of a subset of total available area, allowing border owner to invite others to draw in their temporary space, and the ability to save subsets of a digital whiteboard for longer periods of time

Additionally or alternatively, virtual collaboration application 230 may implement systems and/or methods for coaching users on engagement in meetings and desk work. These systems and methods may be configured to measure a user's activity and to feedback relevant information regarding their current level of engagement. Sensors may detect activity including facial movements, gestures, spoken audio, and/or application use. Resulting data may be analyzed and ranked with priority scores to create statistics such as average speaking time and time spent looking away from screen. As such, these systems and methods may be used to provide contextual feedback in a collaborative setting to monitor and to improve worker effectiveness, ability to set goals for improvement over time, such as increased presence in meetings and reduced time spent on low-priority activities, combined monitoring of device and environmental activity to adapt metrics reported based on user's context, and ability for user to extend to general productivity improvement.

Additionally or alternatively, virtual collaboration application 230 may implement systems and/or methods for automated tracking of meeting behavior and optimization over time. Such systems and methods may act as a planning tool configured to leverage device sensors, user calendars, and/or note-taking applications to track user behavior in meetings and suggest optimizations over time to increase overall effectiveness. As such, these systems and methods may leverage device proximity awareness to automatically track user attendance in scheduled meetings over time and/or use ASR to determine participation levels and mood of meetings (e.g., assess whether attendance is too high, too low, and general logistics).

Additionally or alternatively, virtual collaboration application 230 may implement systems and/or methods for managing meeting or meeting topic time limits in a distributed environment. A meeting host service may provide controlled timing and notification of meeting events through use of contextual information such as speaker identification, key word tracking, and/or detection of meeting participants through proximity. Meeting host and individual participants may be notified of time remaining prior to exceeding time limits. Examples include, but are not limited to, time remaining for (current) topic and exceeding preset time-to-talk limit. In some cases, these systems and methods may be configured to perform aggregation of contextual data with traditional calendar, contact, and agenda information to create unique meeting events such as identifying participants present at start and end of meeting (e.g., through device proximity). Such systems and methods may also be configured to use of contextual data for dynamic management of meeting timing and flow in a distributed environment, and to provide contextual-based feedback mechanism to individuals such as exceeding preset time-to-talk.

Additionally or alternatively, virtual collaboration application 230 may implement systems and/or methods for enhanced trust relations based on peer-to-peer (P2P) direct communications. In many situations people whom have not met in person may be in communication with each other via email, instant messages (IMs), and through social media. With the emerging P2P direct communications, face-to-face communication may be used as an out-of-band peer authentication (“we have met”). By attaching this attribute in a user's contact list, when the user is contacted by other people whose contact information indicates that they have interacted face-to-face, these systems and methods may provide the user a higher level of trust.

Additionally or alternatively, virtual collaboration application 230 may implement systems and/or methods for a gesture enhanced interactive whiteboard. Traditional digital whiteboard uses object size and motion to detect if a user intending to draw on the board or erase a section of the board. This feature can have unintended consequences, such as interpreting pointing as drawing. To address this, and other concerns, these systems and methods may augment the traditional whiteboard drawing/erase detection mechanism, such as light curtain, with gesture recognition system that can track the user's face orientation, gaze and/or wrist articulation to discern user intent.

Additionally or alternatively, virtual collaboration application 230 may implement systems and/or methods for hand raise gesture to indicate needing turn to speak. It has become very commonplace to have remote workers who participate in conference call meetings. One key pain point for remote workers is letting others know that they wish to speak, especially if there are many participants engaged in active discussion in a meeting room with a handful or few remote workers on the conference call. Accordingly, these systems and methods may interpret and raise gesture that is detected by a laptop web cam as automatically indicating to meeting participants that a remote worker needs or wants a turn to speak.

Additionally or alternatively, virtual collaboration application 230 may implement systems and/or methods for providing visual audio quality cues for conference calls. One key pain point anyone who has attended conference calls can attest to is poor audio quality on the conference bridge. More often than not, this poor audio experience is due to background noise introduced by one (or several) of the participants. It is often the case that the specific person causing the bridge noise is at the same time not listening to even know they are causing disruption of the conference. Accordingly, these systems and methods may provide a visual cue of audio quality of speaker (e.g., loudness of speaker, background noise, latency, green/yellow/red of Mean opinion score (MOS)), automated identification of noise makers (e.g., moderator view and private identification to speaker), and/or auto muting/filtering of noise makers (e.g., eating sounds, keyboard typing, dog barking, baby screaming).

Correlating Audio and Events in a Virtual Collaboration Session

Despite the advent of numerous technologies for disseminating information in meetings and collaborative work environments, none provide the capability for correlating discussions to sketches. Collaboration tools such as whiteboarding and screen casting software enable participants to capture and share ideas; however, they do not provide a point of reference nor do they always provide context for what or how an idea was formulated. As such, individuals engaging in an asynchronous review of the meeting materials (i.e., a review that takes place after the meeting) usually have two options.

First, a reviewer may playback the meeting and discussion in its entirety via a recorded audio/video file (e.g., screen cast), if one is available. Alternatively, the reviewer may attempt to deduce what and how various whiteboarding sketches were derived. Either option makes information retrieval very cumbersome (or non-existent), and can lead collaborators to misinformation and ineffective use of time.

To address these concerns, some of the systems and methods described herein may be configured to correlate participants' audio and drawing input by synchronization of event triggers on a given device(s). As input is received (drawing, speech, or both), the data are correlated via time synchronization, packaged together, and persisted on a backend system, which may provide remote synchronous and/or asynchronous viewing and playback features for connected clients. The data streams may result in a series of layered inputs that link together the correlated audio and visual (sketches). This allows participants to revisit previous collaboration sessions. Not only can a user playback the session in its entirety, each drawing layer and corresponding audio can be reviewed non-linearly.

Additionally, these systems and methods may provide robust search capabilities of meeting events. For example, a user may select a particular stroke element in the saved whiteboard sketch to determine who drew it, at what time during the discussion it happened, and hear the period of audio when that particular stroke was created. Similarly, a user may select a moment from the speech-to-text minutes and be taken to the audio and area of the whiteboard sketch that was being drawn at that time. This correlation between audio, text, and sketching provides valuable context when intent might otherwise be misconstrued.

In some implementations, Automatic Speech Recognition (ASR) technology may be used in conjunction with input monitoring such as keystroke and mouse events. ASR allows for speech-to-text processing. The processed text may then be indexed for intelligent information retrieval and playback in conjunction with a given drawing's strokes. The resulting data stream may be aggregated and persisted to a central file repository for indexing, searching and playback capability of specific collaboration/meeting proceedings.

For example, with reference to FIG. 1, a participant operating a given one of client devices 102A-N and/or 105A-N may start or join a virtual collaboration or whiteboarding session via interactive collaboration tool 101. In some cases, all clients and servers may have their respective system clocks synchronized, for example, via the Network Time Protocol (NTP). Such technique may provide data synchronization of drawing, voice and text packets sent/received across the network.

As the whiteboarding session takes place, session data may be persisted to a database or the like. Interactive collaboration tool 101 may then host the whiteboarding session such that other participants operating other ones of client devices 102A-N and/or 105A-N can view the virtual whiteboard. A given client device then listens for speech and monitors an input device (e.g., a touch screen, mouse, etc.) for drawings made by the participant on the virtual whiteboard. When the participant speaks, the client device may use an ASR program to convert that speech to text. Client devices 102A-N and/or 105A-N may then synchronize a participant's plot points, audio, and text stream, and may store that synchronized data locally.

Client devices 102A-N and/or 105A-N may then transmit the synchronized data for remote persistence in a database, and interactive collaboration tool 101 may store the entire whiteboard session as well (including, for example, other synchronized data collected from other participants). Then, either at a later point during the whiteboarding session or after termination of the session, another user (or the participants themselves) may asynchronously retrieve the data stored in the database via a web server for playback view.

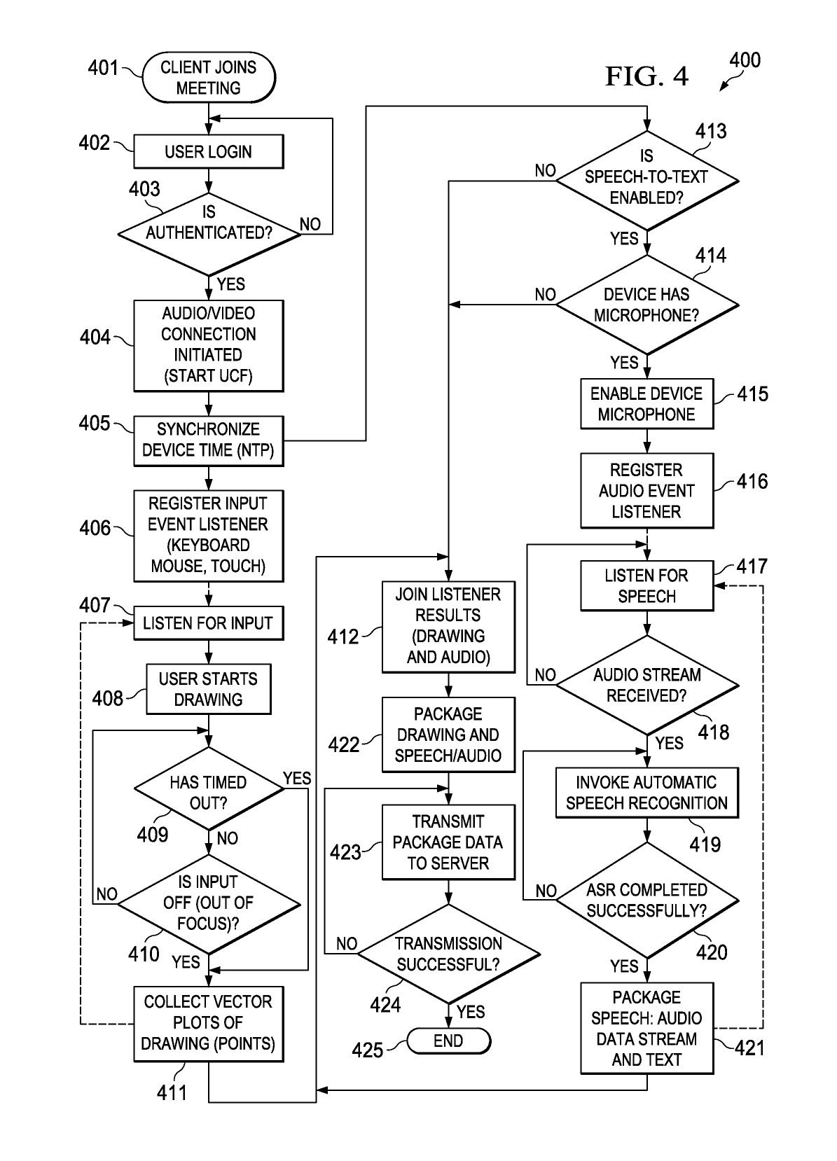

To further illustrate the foregoing, FIG. 4 is a flowchart of method 400 for drawing and audio correlation. In some embodiments, method 400 may be performed, at least in part, by NUI framework 205 of client platform 201 executed by one of client devices 102A-N and/or 105A-N. As shown, method 400 begins at block 401. At block 402, method 400 allows a user or participant to login. Block 403 determines if the user is authenticated. If not, control returns to block 402. Otherwise, at block 404, an audio/video connection is initiated, for example as a part of a virtual collaboration or whiteboarding session.

At block 405, method 400 may include synchronizing the device time, for example using the NTP protocol. At block 406, method 400 may include registering an input event listener—that is, a routine configured to record keyboard strokes, mouse actions, touch gestures, etc. Block 407 includes listening for an input. At block 408, the user may start drawing on a virtual whiteboard. Block 409 determines if the user's drawing has timeout, that is, if a preselected timer has expired. If so, block 411 collects vector plots and/or points from the user's drawing. Otherwise, at block 410, method 400 includes determining if the input device is off and/or out of focus. If not, control returns to block 409; otherwise control passes on to block 411. In some cases, a vector of plotted points for tracing the image may be captured either upon configured timeout (e.g., 5 minutes) or when user stops drawing for consistent time frame (e.g., no input for 5 seconds). Also, a loop may be formed between blocks 411 and 407 to enable continuous capture of input events.

At block 413, method 400 includes determining if speech to text is enabled. If not control passes to block 412. Otherwise block 414 determines if the client device has a microphone. If not, then again control passes to block 412. Otherwise block 415 enables the device's microphone. At block 416, method 400 may include registering an audio event listener—i.e., a routine configured to record audio. At block 417, the audio event listen may listen for speech. Block 418 determines if an audio stream has been received. For example, the participant may speak, which triggers an event for capturing the audio data stream. If not, control returns to block 417. Otherwise block 419 invokes an ASR or speech-to-text procedure. Block 420 determines if the ASR procedure has completed successfully. If not, control returns to block 419. Otherwise, at block 421, method 400 includes packaging the speech/audio data stream and the resulting text in synchronized manner, and control passes to block 412. Similarly as above, here a loop may be formed between blocks 421 and 417 to enable continuous capture of speech/audio.

It should be noted that, in some implementations, the operation(s) of blocks 406 and 413 (and their respective subsequent blocks) may be executed in parallel, for example, via forked process or threads. At block 412, the synchronized drawing, audio, and/or text may be joined together, and block 422 may package these various data elements into a file or the like. Simultaneously, the whiteboard input may be displayed as an output to a projector or the like. The file may then be persisted locally by the client device. At block 423, method 400 may transmit the file to a web server, for example. Block 424 determines if the transmission has been successful. If not, control returns to block 423. Otherwise, method 400 ends at block 425.

In various embodiments, the stroke drawing and audio correlation technique outlined above may allow for both synchronous and asynchronous viewing in conjunction with intelligent information retrieval, thus providing a collaborative platform for information sharing and historical reference of collaborative efforts. For example, after the collaboration session, a remote client may access the data for playback viewing. A remote client may query the web server, for example, for a data playback, which is displayed via layered output and whiteboard. The user interface may include playback controls that allow the user to jump ahead and for viewing, listening, or searching for specific content in a non-linear fashion.

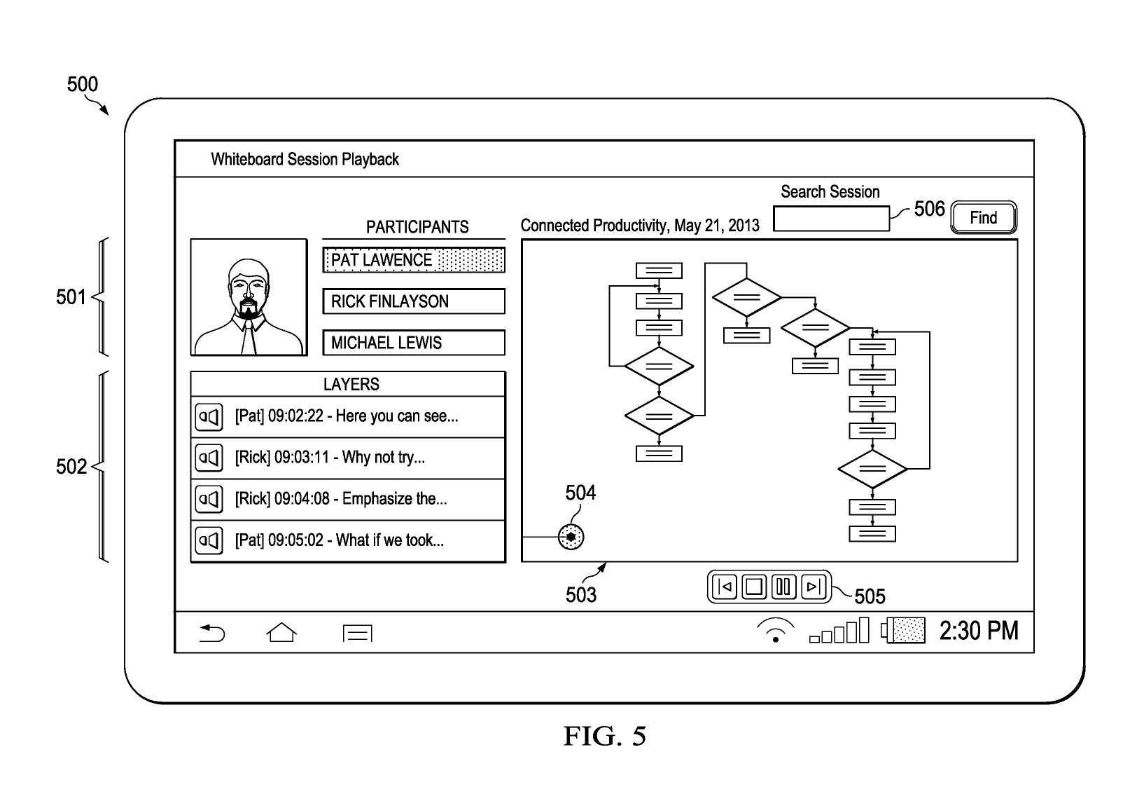

In that regard, FIG. 5 is a screenshot of a client application being executed on a tablet device. In some embodiments, client application 500 may be executed and/or rendered, at least in part, by UI views and models module 203 and/or NUI framework module 205 of client platform 202 running on a given one of client devices 102A-N and/or 105A-N. As illustrated, portion 501 of application 500 may allow a user to select one or more participants in order to filter and/or sort data layers (e.g., drawing, audio, and/or text) associated with those selected participants. Portion 502 shows a historical view of all layers, and allows the user to select audio playback and/or correlated drawing files. The sketch/drawing is replayed in playback area 503, and playback cursor 504 indicates the current playback location on a timeline. Playback controls 505 allow the user to stop, pause, rewind, or forward the recorded session, and search box 506 allows the user to search an associated text layer.

More generally, the systems and methods described above may be used to record any discrete collaboration event taking place during a virtual collaboration or whiteboarding session (sharing a presentation slide, typing notes, etc.), and to synchronize that event in a distinct layer separate from the recorded audio, vector data, and/or text data. For example, in some cases, the event may include the sharing of content between a given participant and another participant, such that the system may store a representation or copy the content along a common timeline. This correlation may allow either user to subsequently review a transcript of the conversation that took place when that piece of content was shared. In another example, the event may include initiation of a private collaboration session between a given participant and another participant to the exclusion of yet another participant. As such, the system may store an indication of the private collaboration session along the common timeline, in a separate layer. As will be understood by a person of ordinary skill in the art in light of this disclosure, any discrete collaboration event may be correlated with a session's audio and/or drawings.

Scrolling Marquee in a Virtual Collaboration Session

Although numerous technologies for disseminating information in meeting and collaborative work environments exist, none of them provide the capability for real-time voice and data sharing. Most meetings provide recordings for later playback upon the meeting's conclusion; however, there is no mechanism for a participant to join a meeting in-progress and be provided with context and detailed dialogue without disrupting the discussion. Meeting participants, who are multitasking and distracted from the discussion, lack context and the ability to backtrack into what has already been spoken. This creates issues where a user must “catch-up” to the topic discussed at-hand, which can lead to redundant conversations, derailed agendas, and overall communication breakdown.

To address these, and other concerns, systems and method described herein may use Automatic Speech Recognition (ASR) technology combined with a client-server model and techniques for synchronizing the converted speech's text transcript for real-time viewing and later audio playback within a scrolling marquee (e.g., a “News Ticker”). The processed text may then be indexed for intelligent information retrieval and playback in conjunction with a given drawing's strokes. The resulting data stream may be aggregated and persisted to a central file repository for indexing, searching and playback capability of specific collaboration/meeting proceedings.

In some embodiments, a horizontally scrolling marquee may be configured to provide rich media content for consumption, such as a recorded audio stream. In conjunction to the scrolling text, the audio file may be embedded or provide a hyperlink for playback.

For example, with reference to FIG. 1, a participant operating a given one of client devices 102A-N and/or 105A-N may start or join a virtual collaboration or whiteboarding session via interactive collaboration tool 101. In some cases, all clients and servers may have their respective system clocks synchronized, for example, via the Network Time Protocol (NTP). Such technique may provide data synchronization of drawing, voice and text packets sent/received across the network.

Interactive collaboration tool 101 may then host the whiteboarding session such that other participants operating other ones of client devices 102A-N and/or 105A-N can view a virtual whiteboard. The given client device then listens for speech originated by the participant during the session. When the participant speaks, his or her respective client device 102A-N and/or 105A-N may use an ASR program to convert that speech to text. In some cases, the ASR process may be cloud-based, such that the client device transmits the audio stream to a web service that performs the ASR procedure and returns the resulting text to the client device. Client devices 102A-N and/or 105A-N may then transmit an audio and text stream for remote persistence in a database. Then another user or participant retrieve the text stored in the database via a web server or the like, and may display the text data in a horizontally scrolling marquee.

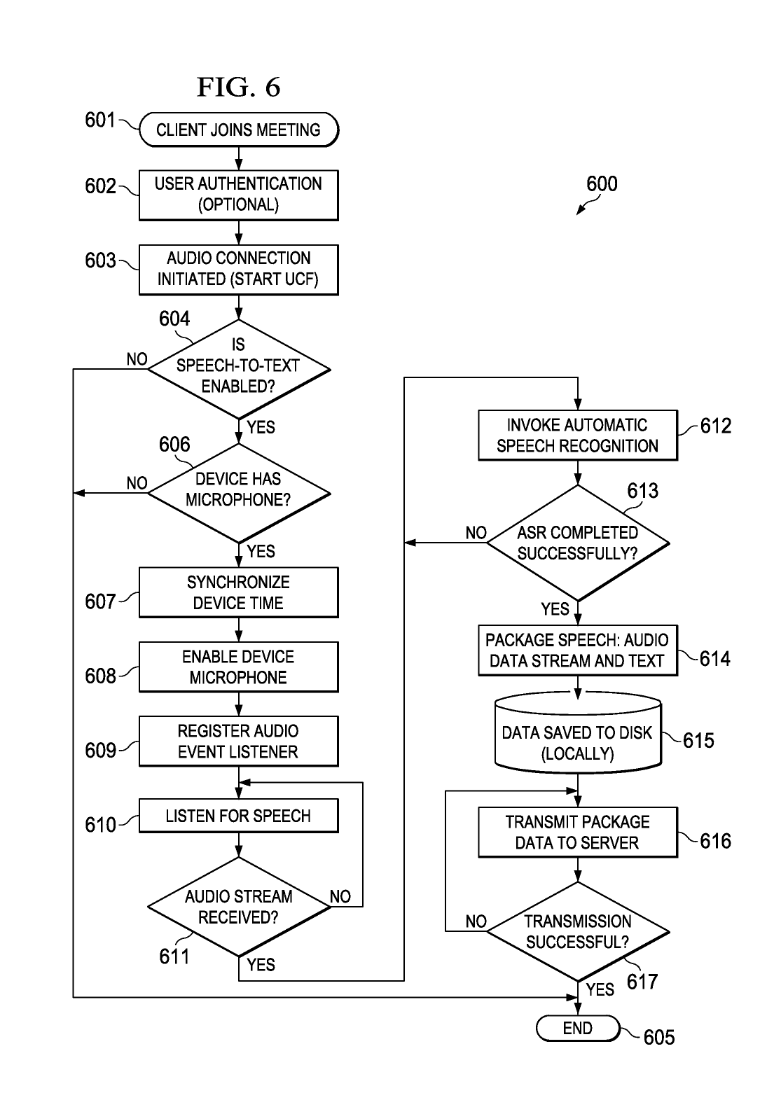

To further illustrate the foregoing, FIG. 6 is a flowchart of a method for transmitting speech-to-text marquee data. In some embodiments, method 600 may be performed, at least in part, by NUI framework 205 of client platform 202 executed by a client devices 102A-N and/or 105A-N. At block 601, one or many clients join a meeting/collaborative setting. At block 602, method 600 may determine whether the user is authenticated, and block 603 initiated an audio connection, for example, with via interactive collaboration tool 101. At block 604, method 600 may determine whether speech-to-text is enabled. If not, method 600 ends at block 605. Otherwise block 606 may determine whether the client device has a microphone. If not, then again method 600 ends at block 605, otherwise control passes to block 607.

At block 607, the client device's time may be synchronized and, at block 608 the microphone is enabled, and block 609 registers an audio event listener. At block 610, method 600 listens for speech. Block 611 determines whether an audio stream is received. For example, a participant may speak, which triggers an event for capturing the audio data stream. If not, control returns to block 610; otherwise block 612 invokes an ASR process. Block 613 determines if the ASR process completed successfully. If not, control returns to block 612, otherwise block 614 packages the speech/audio data stream and ASR text, and block 615 saves the data to a local memory (e.g., a disk drive). At block 616, method 600 includes sending the packaged data to a server such as, for instance, a web server. If the transmission is determined to be successful at block 617, then method 600 ends at block 605. Otherwise control returns to block 616.

Later, a remote client may query the backend service for a data playback, which is displayed via a scrolling text marquee. The scrolling data may support touch gesturing that allows a user to swipe forward or backwards across the text for viewing content in a linear fashion, as illustrated in FIG. 9.

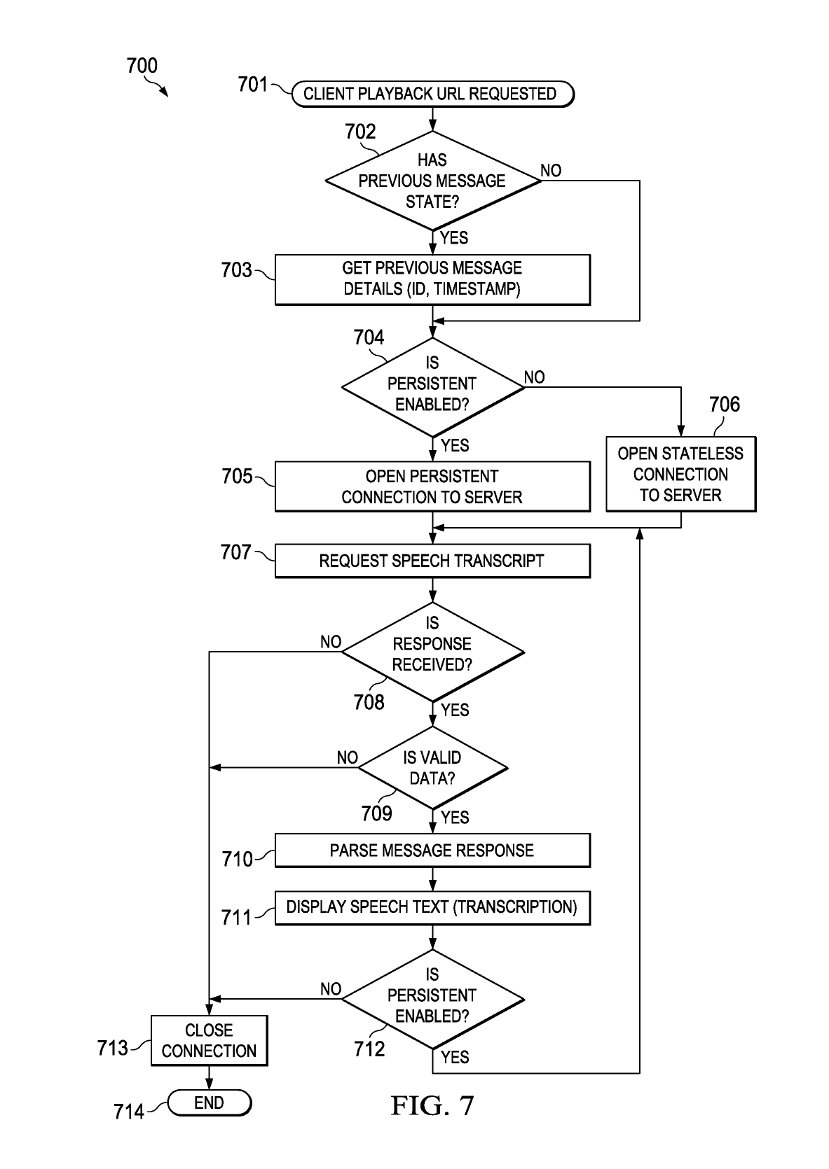

To provide a near real-time playback of speech-to-text the client opens a persistent network connection. As speech and audio data is received, these data may be processed and immediately dispersed to listening clients for consumption. In that regard, FIG. 7 is a flowchart of a method for receiving speech-to-text marquee data according to some embodiments. At block 701, a client requests the Uniform Resource Locator (URL) of the playback data. At block 702, method 700 determines if the previous message state is known. If not, then block 703 obtains the previous message details (e.g., identification, timestamp, etc.). Otherwise, at block 704, method 700 determines is persistency is enabled. If so, block 705 opens a persistent connection to the web server. Otherwise, block 706 opens a stateless connection to the web server.

At block 707, method 700 requests a speech transcript. If the response is not received at block 708, block 713 closes the connection with the web server, and method 700 ends at block 714. Otherwise block 709 determines if the data is valid. If not, again block 713 closes the connection and method 700 ends at block 714. Otherwise block 710 parses the message response and block 711 displays the speech text transcription in a horizontally scrollable marquee. If block 712 determines that a persistent connection was established, control returns to block 707. Otherwise block 713 closes the connection and method 700 ends at block 714.

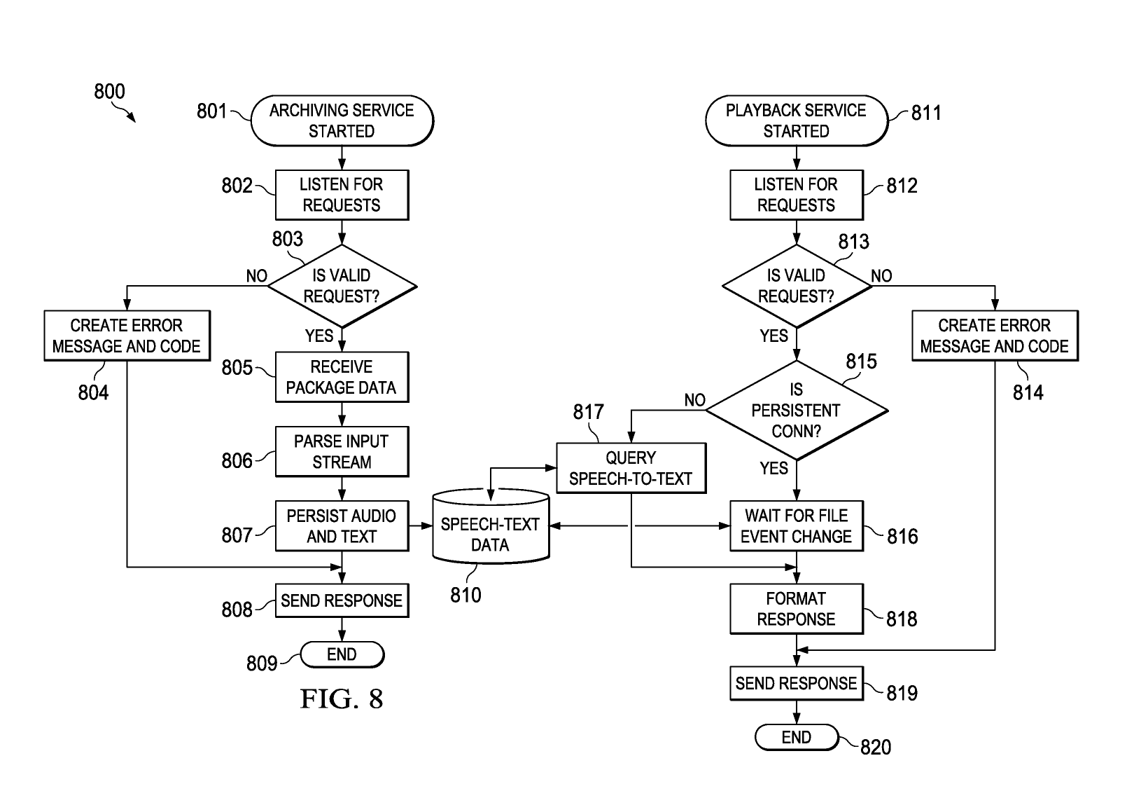

FIG. 8 is a flowchart of a method for serving speech-to-text marquee data. In some embodiments, method 800 may be performed, at least in part, by a web server executing server platform 213. Generally speaking, method 800 defines the server-side flows for archiving incoming data and handling retrieval for playback. In order to maintain the speech's dialog consistency, all data persisted to disk may be time stamped and synchronized across clients. The server maintains the state of the data and watches for changes (e.g., file polling) to trigger a retrieval a client notification for displaying the latest text stream to the scrolling marquee.

At block 801, method 800 includes starting the archiving service, and block 802 listens for client requests. If block 803 determines that the request is not valid, block 804 creates an error message and/or code, block 808 sends a response to a requesting client, and method 800 ends at block 809. Otherwise, block 805 receives package data, block 806 parses the input stream, and block 807 persists the audio and text from the package data in database 810.

At block 811 a playback service may be started, and block 812 may listen for client requests. If block 813 determines that the request is not valid, block 814 creates an error message and/or code, block 819 sends a response to a requesting client, and method 800 ends at block 820. Otherwise, block 815 determines is the client's connection is persistent. If not, block 817 may query the speech-to-text data stored at block 810. Otherwise block 816 waits for a file event change. At block 818, method 800 formats the response to the client. As before, block 819 sends a response to a requesting client, and method 800 ends at block 820.

FIG. 9 is a screenshot illustrating a horizontally scrolling marquee displayed by a client device according to some embodiments. As shown, portion 901 lists the names of participants of the virtual collaboration or whiteboarding session, as well as a description of their respective statuses or locations. Portion 902 shows a vertical transcript of the session, and portion 903 shows a real-time, horizontally scrollable marquee. In various implementations, the marquee may be operated using touch gesturing 904 for forwards and backwards scrolling.

Within the marquee, the full text transcript is provided as it becomes available. The full text transcript provides authorized users the ability to review the real-time discussion during or after a meeting. This is useful in providing a quick summary for participants joining late to a meeting or archiving a detailed the dialogue context for historical review. In the event that the speech transcription is not perfect, the participant has the ability to listen to a specific portion of the meeting. By clicking on the “listen” icon in portion 902 or words within the marquee. The participant can then playback a specific section of recorded speech that correlates to the text transcription, during or after the virtual collaboration session.

In some embodiments, the horizontally scrolling marquee may be configured to allow a session participant to send content to another participant during the virtual collaboration session. For example, the participant may drag and drop the content onto the marquee, and the content may then be distributed to other participants using techniques similar to those shown in FIG. 8.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS), comprising:
a processor; and
a memory coupled to the processor, the memory including program instructions stored thereon that, upon execution by the processor, cause the IHS to:
capture speech originated by a given one of a plurality of participants during a virtual collaboration session;
capture a discrete collaboration event originated by the given participant during the virtual collaboration session;
synchronize the speech with the event; and
store the synchronized speech and event.

2. The IHS of claim 1, wherein the virtual collaboration session includes a whiteboarding session.

3. The IHS of claim 2, wherein the discrete collaboration event includes a drawing on a whiteboard, and wherein capturing the discrete collaboration event includes capturing a vector of plotted points on the whiteboard.

4. The IHS of claim 3, wherein the program instructions, upon execution by the processor, further cause the IHS to capture the vector of plotted points upon expiration of a configurable timer or in response to the participant having stopped drawing on the whiteboard for a preselected period of time.

5. The IHS of claim 1, wherein the discrete collaboration event includes a sharing of content between the given participant and at least another one of the plurality of participants, and wherein storing the synchronized speech and event includes storing a copy of the content.

6. The IHS of claim 1, wherein the discrete collaboration event includes an initiation of a private collaboration session between the given participant and at least another one of the plurality of participants to the exclusion of at least yet another of the plurality of participants, and wherein storing the synchronized speech and event includes storing an indication of the private collaboration session.

7. The IHS of claim 1, wherein the synchronized speech and event are stored in distinct layers of a same file.

8. The IHS of claim 1, wherein the program instructions, upon execution by the processor, further cause the IHS to:
convert the speech to text;
synchronize the text with the speech and the event; and
store the synchronized text, speech, and event.

9. The IHS of claim 1, wherein the program instructions, upon execution by the processor, further cause the IHS to transmit the synchronized speech and event to a remotely located server.

10. A method, comprising:
receiving data at an Information Handling System (IHS) from a given one of a plurality of participants of a whiteboarding session, wherein the data includes speech synchronized with an indication of a discrete collaboration event, wherein the speech and the discrete collaboration event are originated by the given participant during the whiteboarding session, wherein the discrete collaboration event includes a drawing on a whiteboard, and wherein the data includes a vector of plotted points on the whiteboard; and
storing the data.

11. The method of claim 10, wherein the discrete collaboration event further includes a sharing of content between the given participant and at least another one of the plurality of participants, and wherein the data further includes a representation of the content.

12. The method of claim 10, wherein the discrete collaboration event further includes an initiation of a private collaboration session between the given participant and at least another one of the plurality of participants to the exclusion of at least yet another of the plurality of participants, and wherein the data further includes a representation of the private collaboration session.

13. The method of claim 10, further comprising:
receiving, at the IHS from a requesting device, a request to playback at least a portion of the whiteboarding session; and
providing a portion of the data corresponding to the request to the requesting device.

14. The method of claim 13, further comprising allowing the requesting device to playback the whiteboarding session in a non-linear manner.

15. The method of claim 10, wherein the data includes text corresponding to the speech and wherein the text is synchronized with the speech and the event, the method further comprising:
allowing the requesting device to search for a keyword in the text; and
providing a portion of the data corresponding to the keyword to the requesting device.

16. The method of claim 10, further comprising:
receiving additional data at the IHS from at least another one of the plurality of participants, wherein the data includes other speech synchronized with an indication of another discrete collaboration event, wherein the other speech and the other discrete collaboration event are originated by at least another participant during the whiteboarding session;
synchronizing the data with the additional data; and
storing the additional data.

17. The method of claim 16, further comprising:
receiving, at the IHS from a requesting device, a request to playback at least a portion of the whiteboarding session associated with a selected one or more of the plurality of participants to the exclusion of at least another one or more of the plurality of participants; and
providing a portion of the data corresponding to the request to the requesting device.

18. A non-transitory computer-readable medium having program instructions stored thereon that, upon execution by an Information Handling System (IHS), cause the IHS to:
receive data from a given one of a plurality of participants of a virtual collaboration session, wherein the data includes an audio portion synchronized with a text portion corresponding to the audio, and wherein the audio is generated by the given participant during the virtual collaboration session; and
provide the text portion to another one of the plurality of participants during the virtual collaboration session, wherein the text portion is configured to be displayed on a horizontally scrolling marquee via a graphical interface displayed to the other participant.

19. The non-transitory computer-readable medium of claim 18, wherein the horizontally scrolling marquee is configured to allow the other participant to backward or forward scroll the text using a gesture during the virtual collaboration session.

20. The non-transitory computer-readable medium of claim 18, wherein the horizontally scrolling marquee is configured to allow the other participant to send content to the given participant via the IHS during the virtual collaboration session by dragging and dropping the content onto the marquee.
